(19) United States
(12) Patent Application Publication
(10) Pub. No.: US 2002/0119368 A1
(43) Pub. Date: Aug. 29, 2002

(54) Anode structure for metal air electrochemical cells and method of manufacture thereof

(76) Inventor: George Tzong-Chyi Tzeng, Elmsford, NY (US)

Correspondence Address: RALPH J. CRISPINO, eVionyx, Inc., 85 Executive Blvd., Elmsford, NY, 10523, US

(21) Appl. No.: 10/074,873

(22) Filed: Feb. 11, 2002

Related U.S. Application Data
(60) Provisional application No. 60/267,933, filed on Feb. 9, 2001.

(51) Int. Cl. B05D 5/12; H01M 2/18

(52) U.S. Cl. 429/137; 427/58

(57) ABSTRACT

The anode structure comprises a metal constituent and a base at least partially contained by a separator. Additionally, a method of manufacture of an anode structure is provided, wherein a metal constituent and a base are integrally formed into a substantially solid structure, and a separator is provided to at least partially contain the metal constituent and the base.

### RELATED APPLICATIONS

This application claims priority to United States Provisional Application Ser. No. 60/267,933, filed Feb. 9, 2001 entitled “ANODE STRUCTURE FOR METAL AIR ELECTROCHEMICAL CELLS AND METHOD OF MANUFACTURE THEREOF,” which is incorporated by reference herein.

### BACKGROUND OF THE INVENTION

1. Field of the Invention

The present invention relates to metal anodes for metal air electrochemical cells, and more particularly to anodes incorporating electrolyte and the methods for manufacture thereof.

2. Description of the Prior Art

Electrochemical power sources are devices through which electric energy can be produced by means of electrochemical reactions. These devices include metal air electrochemical cells such as zinc air and aluminum air batteries. Certain metal electrochemical cells employ an anode comprised of metal particles that are fed into the cell and consumed during discharge. Such electrochemical cells are often called refuelable batteries. Zinc air refuelable battery cells include an anode, a cathode, and an electrolyte. The anode is generally formed of zinc particles immersed in electrolyte. The cathode includes a catalyzed layer for reducing oxygen. A separator is typically disposed between the anode and cathode to provide electrical isolation. The electrolyte is usually a caustic liquid that is ionic conducting but not electrically conducting.

Metal air electrochemical cells have numerous advantages over traditional hydrogen-based fuel cells. Metal air electrochemical cells have high energy density (W*hr/Liter), high specific energy (W*hr/kg), and run under ambient temperature. Further, the supply of energy provided from metal air electrochemical cells is virtually inexhaustible because the fuel, such as zinc, is plentiful and can exist either as the metal or its oxide. Additionally, solar, hydroelectric, or other forms of energy can be used to convert the metal from its oxide product back to the metallic fuel form. Unlike conventional hydrogen-oxygen fuel cells that require refilling, the fuel of metal air electrochemical cells is recoverable by electrically recharging. The fuel may be solid state, therefore, safe and easy to handle and store. In contrast to hydrogen-oxygen fuel cell, which use methane, natural gas, or liquefied natural gas to provide as source of hydrogen, and emit polluting gases, the metal air electrochemical cells results in zero emission.

The metal air electrochemical cells operate at ambient temperature, whereas hydrogen-oxygen fuel cells typically operate at temperatures in the range of 150° C. to 1000° C. Metal air electrochemical cells are capable of delivering higher output voltages (1.5-3 Volts) than conventional fuel cells (<0.8V). Due to these advantages, metal air electrochemical cells can be used as power sources of all kind of applications, like stationary or mobile power plant, electric vehicle or portable electronic device, etc.

One of the principle obstacles of metal air electrochemical cells is the prevention of leakage of the electrolyte, typically a liquid electrolyte. Special attention is required to prevent spillage of electrolyte, which may contaminate the user or environment during many conventional refueling processes.

A further obstacle relates to excess air within the anode (e.g., trapped between the anode and the separator during refueling). The trapped air is difficult to release through the separator. Once the separator is wetted by the electrolyte, the surface tension of the electrolyte will block the porous structure of the separator to prevent the air to escape. This trapped air typically causes uneven discharging and reduces overall cell performance.

Another obstacle relates to refueling of metal air cells. Typically, anodes tend to expansion during discharging. If the clearance between the anode and cathode is not large enough to accommodate the anode expansion, the cathode may be damaged and hence render refueling difficult or impossible.

There remains a need in the art for an improved electrode, particularly a metal anode, for metal air batteries electrochemical cells.

### SUMMARY OF THE INVENTION

The above-discussed and other problems and deficiencies of the prior art are overcome or alleviated by the several methods and apparatus of the present invention, wherein an anode for a metal air electrochemical cell is provided. The anode structure comprises a metal constituent and a base at least partially contained by a separator. Additionally, a method of manufacture of an anode structure is provided, wherein a metal constituent and a base are integrally formed into a substantially solid structure, and a separator is provided to at least partially contain the metal constituent and the base.

The above-discussed and other features and advantages of the present invention will be appreciated and understood by those skilled in the art from the following detailed description and drawings.

### BRIEF DESCRIPTION OF THE DRAWINGS

Numerous other advantages and features of the present invention will become readily apparent from the following detailed description of preferred embodiments when read in conjunction with the accompanying drawings, wherein:

FIG. 1 is a schematic representation of an embodiment of a metal air electrochemical cell;

FIG. 2 is a schematic representation of another embodiment of a metal air electrochemical cell;

FIG. 3 depicts an anode in one step of a process herein;

FIG. 4 shows the anode submersed in an electrolyte;

FIG. 5 shows insertion of the anode having electrolyte therein into a casting mold;

FIG. 6 shows a completed anode structure;

FIG. 7 is a detailed view of the surface of the anode structure; and

FIG. 8 is another embodiment of an anode structure.

### DETAILED DESCRIPTION OF THE ILLUSTRATIVE EMBODIMENTS

An anode structure for a metal air electrochemical cell is provided. The anode structure comprises a metal constituent and a base at least partially contained by a separator. Additionally, a method of manufacture of an anode structure is provided, wherein a metal constituent and a base are integrally formed, and a separator is provided to at least partially contain the metal constituent and the base. The anode structure may also include a gelling agent to gel a base when the base is provided in aqueous form.

Referring now to the drawings, an illustrative embodiment of the present invention will be described. For clarity of the description, like features shown in the figures shall be indicated with like reference numerals and similar features as shown in alternative embodiments shall be indicated with similar reference numerals.

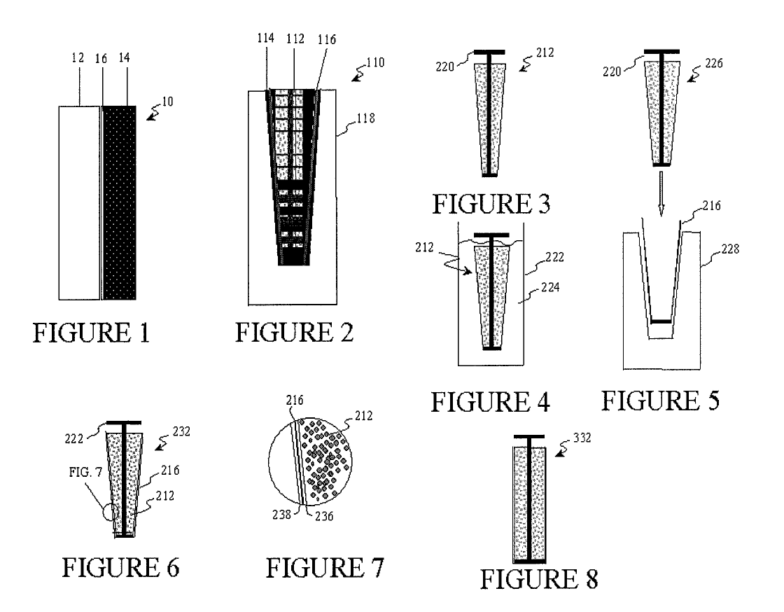

FIG. 1 is a schematic representation of an electrochemical cell 10. Electrochemical cell 10 may be a metal air or metal oxygen cell, wherein the metal is supplied from a metal anode 12 and the air or oxygen is supplied to an oxygen cathode 14. The anode 12 and the cathode 14 are maintained in electrical isolation from on another by a separator 16. Oxygen from the air or another source is used as the reactant for the air cathode 14 of the metal air cell 10. When oxygen reaches the reaction sites within the cathode 14, it is converted into hydroxyl ions together with water. At the same time, electrons are released to flow as electricity in the external circuit. The hydroxyl travels through the separator 16 to reach the metal anode 12. When hydroxyl reaches the metal anode (in the case of an anode 12 comprising zinc), zinc hydroxide is formed on the surface of the zinc. Zinc hydroxide decomposes to zinc oxide and releases water back to the alkaline solution. The reaction is thus completed.

The anode reaction is:

Zn+4OH⁻→Zn(OH)₄²⁻+2e (1)

Zn(OH)₄²⁻→ZnO+H₂O+2OH⁻ (2)

The cathode reaction is:

½O₂+H₂O+2e→2OH⁻ (3)

Thus, the overall cell reaction is:

Zn+½O₂→ZnO (4)

The anode 12 provides a solid or substantially solid fuel source. The anode 12 includes metal particles, a gelling agent, and an electrolyte at least partially contained by a separator 16. Additionally, a current collector may also be provided in electrical contact with the anode 12 to facilitate connection thereto. Further, one or more additional constituents such as binders or additives, may optionally be included. Preferably, the formulation optimizes ion conduction rate, density, and overall depth of discharge, while minimizing water leakage from the cell 10, and more preferably eliminating such water leakage.

The metal constituent may comprise mainly metals and metal compounds such as zinc, calcium, lithium, magnesium, ferrous metals, aluminum, oxides of at least one of the foregoing metals, or combinations and alloys comprising at least one of the foregoing metals. These metals may also be mixed or alloyed with constituents including, but not limited to, bismuth, calcium, magnesium, aluminum, indium, lead, mercury, gallium, tin, cadmium, germanium, antimony, selenium, thallium, oxides of at least one of the foregoing metals, or combinations comprising at least one of the foregoing constituents. During conversion in the electrochemical process, the metal is generally converted to a metal oxide.

The metal constituent may be provided in the form of powder, fibers, dust, granules, flakes, needles, pellets, or other particles. In certain embodiments, granule metal, particularly zinc alloy metal, is provided as the metal constituent. In other embodiments, particularly where it is desirable to minimize or eliminate reliance on binder materials to maintain structural integrity, may be used. Additionally, when fibrous materials are formed into a desired shape, the structure generally offers a greater porosity than, for example, those fabricated from other metal forms (e.g., powder) with typical amounts of binder materials.

The anode current collector may be any electrically conductive material capable of providing electrical conductivity and optionally capable of providing support to the anode 12. The current collector may be formed of various electrically conductive materials including, but not limited to, copper, brass, ferrous metals such as stainless steel, nickel, carbon, electrically conducting polymer, electrically conducting ceramic, other electrically conducting materials that are stable in alkaline environments and do not corrode the electrode, or combinations and alloys comprising at least one of the foregoing materials. The current collector may be in the form of a mesh, porous plate, metal foam, strip, wire, plate, or other suitable structure.

An optional binder may also be used to maintain the structural integrity of the anode. The binder may be any material that generally adheres the anode material and the current collector to form a suitable structure, and is generally provided in an amount suitable for adhesive purposes of the anode. This material is preferably chemically inert to the electrochemical environment. In certain embodiments, the binder material is soluble, or can form an emulsion, in water, and is not soluble in an electrolyte solution. Appropriate binder materials include polymers and copolymers based on polytetrafluoroethylene (e.g., Teflon® and Teflon® T-30 commercially available from E. I. du Pont Nemours and Company Corp., Wilmington, Del.), polyvinyl alcohol (PVA), poly(ethylene oxide) (PEO), polyvinylpyrrolidone (PVP), and the like, and derivatives, combinations and mixtures comprising at least one of the foregoing binder materials. However, one of skill in the art will recognize that other binder materials may be used.

Optional additives may be provided, for example to prevent corrosion. Suitable additives include, but are not limited to polysaccharide, sorbitol, indium oxide; zinc oxide, EDTA, surfactants such as sodium stearate, potassium Lauryl sulfate, Triton® X-400 (available from Union Carbide Chemical & Plastics Technology Corp., Danbury, Conn.), and other surfactants; the like; and derivatives, combinations and mixtures comprising at least one of the foregoing additive materials. However, one of skill in the art will determine that other additive materials may be used.

The electrolyte generally comprises alkaline media to reach the metal anode. In certain embodiments, an ion conducting amount of electrolyte is provided in anode 12. Alternatively, electrolyte is also incorporated in a gel between the anode 12 and the cathode 14. Preferably, sufficient electrolyte is provided to maximize the reaction and depth of discharge. The electrolyte generally may comprise ionic conducting materials such as KOH, NaOH, other materials, or a combination comprising at least one of the foregoing electrolyte media. Particularly, the electrolyte may comprise electrolyte materials including aqueous electrolytes, polymer-based electrolyte membranes, or any combination comprising at least one of the foregoing electrolyte materials. Exemplary polymer-based electrolyte membranes are discussed herein generally related to various separators that may be used.

In one embodiment, a substantially solid electrolyte is sandwiched between a plurality of anodes. Alternatively, the solid electrolyte may be provided in powder or granule form and integrally formed with the anode material. Further, strips, patches, or sheets may be located at certain areas of the anode to maximize anode use. These forms generally allow for an increase in the thickness of the cell without sacrificing depth of discharge, which is particularly useful, for example, for stationary power metal air air applications.

The gelling agent may be any suitable gelling agent in sufficient quantity to provide the desired consistency of the paste. The ratio of base to gelling agent is generally about 10/1 to about 30/1. The gelling agent may be a crosslinked polyacrylic acid (PAA), such as the Carbopol® family of crosslinked polyacrylic acids (e.g., Carbopol® 675) available from B F Goodrich Company, Charlotte, N.C., Alcosorb® G1 commercially available from Allied Colloids Limited (West Yorkshire, GB), and potassium and sodium salts of polyacrylic acid; carboxymethyl cellulose (CMC), such as those available from Aldrich Chemical Co., Inc., Milwaukee, Wis.; hydroxypropylmethyl cellulose; gelatine; polyvinyl alcohol (PVA); poly(ethylene oxide) (PEO); polybutylvinyl alcohol (PBVA); combinations comprising at least one of the foregoing gelling agents; and the like.

The oxygen supplied to the cathode 14 may be from any oxygen source, such as air; scrubbed air; pure or substantially oxygen, such as from a utility or system supply or from on site oxygen manufacture; any other processed air; or any combination comprising at least one of the foregoing oxygen sources.

Cathode 14 may be a conventional air diffusion cathode, for example generally comprising an active constituent and a carbon substrate, along with suitable connecting structures, such as a current collector. Typically, the cathode catalyst is selected to attain current densities in ambient air of at least 20 milliamperes per squared centimeter (mA/cm²), preferably at least 50 mA/cm², and more preferably at least 100 mA/cm². Of course, higher current densities may be attained with suitable cathode catalysts and formulations. The cathode may be a bi-functional, for example, which is capable of both operating during discharging operations and recharging operations (where applicable), or mono-functional, which is intended to operate during discharging operations.

The carbon used is preferably be chemically inert to the electrochemical cell environment and may be provided in various forms including, but not limited to, carbon flake, graphite, other high surface area carbon materials, or combinations comprising at least one of the foregoing carbon forms.

The cathode current collector may be any electrically conductive material capable of providing electrical conductivity and preferably chemically stable in alkaline solutions, which optionally is capable of providing support to the cathode 14. The current collector may be in the form of a mesh, porous plate, metal foam, strip, wire, plate, or other suitable structure. The current collector is generally porous to minimize oxygen flow obstruction. The current collector may be formed of various electrically conductive materials including, but not limited to, copper, ferrous metals such as stainless steel, nickel, chromium, titanium, and the like, and combinations and alloys comprising at least one of the foregoing materials. Suitable current collectors include porous metal such as nickel foam metal.

A binder is also typically used in the cathode, which may be any material that adheres substrate materials, the current collector, and the catalyst to form a suitable structure. The binder is generally provided in an amount suitable for adhesive purposes of the carbon, catalyst, and/or current collector. This material is preferably chemically inert to the electrochemical environment. In certain embodiments, the binder material also has hydrophobic characteristics. Appropriate binder materials include polymers and copolymers based on polytetrafluoroethylene (e.g., Teflon® and Teflon® T-30 commercially available from E. I. du Pont Nemours and Company Corp., Wilmington, Del.), polyvinyl alcohol (PVA), poly(ethylene oxide) (PEO), polyvinylpyrrolidone (PVP), and the like, and derivatives, combinations and mixtures comprising at least one of the foregoing binder materials. However, one of skill in the art will recognize that other binder materials may be used.

The active constituent is generally a suitable catalyst material to facilitate oxygen reaction at the cathode. The catalyst material is generally provided in an effective amount to facilitate oxygen reaction at the cathode. Suitable catalyst materials include, but are not limited to: manganese, lanthanum, strontium, cobalt, platinum, and combinations and oxides comprising at least one of the foregoing catalyst materials. An exemplary air cathode is disclosed in copending, commonly assigned U.S. patent application Ser. No. 09/415,449, entitled “Electrochemical Electrode For Fuel Cell”, to Wayne Yao and Tsepin Tsai, filed on Oct. 8, 1999, which is incorporated herein by reference in its entirety. Other air cathodes may instead be used, however, depending on the performance capabilities thereof, as will be obvious to those of skill in the art.

To electrically isolate the anode from the cathode, a separator is provided between the electrodes, as is known in the art. The separator may be any commercially available separator capable of electrically isolating the anode and the cathode, while allowing sufficient ionic transport therebetween. Preferably, the separator is flexible, to accommodate electrochemical expansion and contraction of the cell components, and chemically inert to the cell chemicals. Suitable separators are provided in forms including, but not limited to, woven, non-woven, porous (such as microporous or nanoporous), cellular, polymer sheets, and the like. Materials for the separator include, but are not limited to, polyolefin (e.g., Gelgard® commercially available from Dow Chemical Company), polyvinyl alcohol (PVA), cellulose (e.g., nitrocellulose, cellulose acetate, and the like), polyethylene, polyamide (e.g., nylon), fluorocarbon-type resins (e.g., the Nafion® family of resins which have sulfonic acid group functionality, commercially available from du Pont), cellophane, filter paper, and combinations comprising at least one of the foregoing materials. The separator 16 may also comprise additives and/or coatings such as acrylic compounds and the like to make them more wettable and permeable to the electrolyte.

In certain embodiments, the separator comprises a membrane having electrolyte, such as hydroxide conducting electrolytes, incorporated therein. The membrane may have hydroxide conducing properties by virtue of: physical characteristics (e.g., porosity) capable of supporting a hydroxide source, such as a gelatinous alkaline material; molecular structure that supports a hydroxide source, such as an aqueous electrolyte; anion exchange properties, such as anion exchange membranes; or a combination of one or more of these characteristics capable of providing the hydroxide source.

For instance, the separator may comprise a material having physical characteristics (e.g., porosity) capable of supporting a hydroxide source, such as a gelatinous alkaline solution. For example, various separators capable of providing ionically conducting media are described in: U.S. Pat. No. 5,250,370 entitled “Variable Area Dynamic Battery,” Sadeg M. Faris, Issued Oct. 5, 1993; U.S. application Ser. No. 08/944,507 filed Oct. 6, 1997 entitled “System and Method for Producing Electrical Power Using Metal Air Fuel Cell Battery Technology,” Sadeg M. Faris, Yuen-Ming Chang, Tsepin Tsai, and Wayne Yao; U.S. application Ser. No. 09/074,337 filed May 7, 1998 entitled “Metal-Air Fuel Cell Battery Systems,” Sadeg M. Faris and Tsepin Tsai; U.S. application Ser. No. 09/110,762 filed Jul. 3, 1998 entitled “Metal-Air Fuel Cell Battery System Employing Metal Fuel Tape and Low-Friction Cathode Structures,” Sadeg M. Faris, Tsepin Tsai, Thomas J. Legbandt, Muguo Chen, and Wayne Yao; U.S. Pat. No. 6,190,792 issued Feb. 20, 2001 entitled “Ionically-Conductive Belt Structure for Use in a Metal-Air Fuel Cell Battery System and Method of Fabricating the Same,” Sadeg M. Faris, Tsepin Tsai, Thomas Legbandt, Wenbin Yao, and Muguo Chen; U.S. application Ser. No. 09/116,643 filed Jul. 16, 1998 entitled “Metal-Air Fuel Cell Battery System Employing Means for Discharging and Recharging Metal-Fuel Cards,” Sadeg M. Faris, Tsepin Tsai, Wenbin Yao, and Muguo Chen; U.S. application Ser. No. 09/268,150 filed Mar. 15, 1999 entitled “Movable Anode Fuel Cell Battery,” by Tsepin Tsai and William Morris; U.S. application Ser. No. 09/526,669 filed Mar. 15, 2000 “Movable Anode Fuel Cell Battery,” Tsepin Tsai, William F. Morris, all of which are herein incorporated by reference.

In general, the type of material having physical characteristics capable of supporting a hydroxide source may comprise an electrolyte gel. The electrolyte gel may be either applied directly on the surface of the evolution and/or reduction electrodes, or applied as a self supported membrane between the evolution and reduction electrodes. Alternatively, the gel may be supported by a substrate and incorporated between the evolution and reduction electrodes.

The electrolyte (either within any one of the variations of the separator herein, or as a liquid within the cell structure in general) generally comprises ion conducting material to allow ionic conduction between the metal anode and the cathode. The electrolyte generally comprises hydroxide-conducting materials such as KOH, NaOH, LiOH, RbOH, CsOH or a combination comprising at least one of the foregoing electrolyte media. In preferred embodiments, the hydroxide-conducting material comprises KOH. Particularly, the electrolyte may comprise aqueous electrolytes having a concentration of about 5% ionic conducting materials to about 55% ionic conducting materials, preferably about 10% ionic conducting materials to about 50% ionic conducting materials, and more preferably about 30% ionic conducting materials to about 40% ionic conducting materials.

The gelling agent for the membrane may be any suitable gelling agent in sufficient quantity to provide the desired consistency of the material. The gelling agent may be a crosslinked polyacrylic acid (PAA), such as the Carbopol® family of crosslinked polyacrylic acids (e.g., Carbopol® 675) available from B F Goodrich Company, Charlotte, N.C., Alcosorb® G1 commercially available from Allied Colloids Limited (West Yorkshire, GB), and potassium and sodium salts of polyacrylic acid; carboxymethyl cellulose (CMC), such as those available from Aldrich Chemical Co., Inc., Milwaukee, Wis.; hydroxypropylmethyl cellulose; gelatine; polyvinyl alcohol (PVA); poly(ethylene oxide) (PEO); polybutylvinyl alcohol (PBVA); combinations comprising at least one of the foregoing gelling agents; and the like. Generally, the gelling agent concentration is from about 0.1% to about 50% preferably about 2% to about 10%.

The optional substrate may be provided in forms including, but not limited to, woven, non-woven, porous (such as microporous or nanoporous), cellular, polymer sheets, and the like, which are capable of allowing sufficient ionic transport between the reduction and evolution electrodes. In certain embodiments, the substrate is flexible, to accommodate electrochemical expansion and contraction of the cell components, and chemically inert to the cell materials. Materials for the substrate include, but are not limited to, polyolefin (e.g., Gelgard® commercially available from Daramic Inc., Burlington, Mass.), polyvinyl alcohol (PVA), cellulose (e.g., nitrocellulose, cellulose acetate, and the like), polyamide (e.g., nylon), cellophane, filter paper, and combinations comprising at least one of the foregoing materials. The substrate may also comprise additives and/or coatings such as acrylic compounds and the like to make them more wettable and permeable to the electrolyte.

In other embodiments of a hydroxide-conducting membrane as a separator, a molecular structure is provided that supports a hydroxide source, such as an aqueous electrolyte. Such membranes are desirable in that conductivity benefits of aqueous electrolytes may be achieved in a self supported solid state structure. In certain embodiments, the membrane may be fabricated from a composite of a polymeric material and an electrolyte. The molecular structure of the polymeric material supports the electrolyte. Cross-linking and/or polymeric strands serve to maintain the electrolyte.

In one example of a conductive separator, a polymeric material such as polyvinyl chloride (PVC) or poly(ethylene oxide) (PEO) is formed integrally with a hydroxide source as a thick film. In a first formulation, one mole of KOH and 0.1 mole of calcium chloride are dissolved in a mixed solution of 60 milliliters of water and 40 milliliters of tetrahydrogen furan (THF). Calcium chloride is provided as a hygroscopic agent. Thereafter, one mole of PEO is added to the mixture. In a second formulation, the same materials for the first formula are used, with the substitution of PVC for PEO. The solution is cast (or coated) as a thick film onto substrate, such as polyvinyl alcohol (PVA) type plastic material. Other substrate materials preferably having a surface tension higher than the film material may be used. As the mixed solvents evaporate from the applied coating, an ionically-conductive solid state membrane (i.e. thick film) is formed on the PVA substrate. By peeling the solid state membrane off the PVA substrate, a solid-state ionically-conductive membrane or film is formed. Using the above formulations, it is possible to form ionically-conductive films having a thickness in the range of about 0.2 to about 0.5 millimeters.

Other embodiments of conductive membranes suitable as a separator are described in greater detail in: U.S. patent application Ser. No. 09/259,068, entitled “Solid Gel Membrane”, by Muguo Chen, Tsepin Tsai, Wayne Yao, Yuen-Ming Chang, Lin-Feng Li, and Tom Karen, filed on Feb. 26, 1999; U.S. patent application Ser. No. 09/482,126 entitled “Solid Gel Membrane Separator in Rechargeable Electrochemical Cells”, by Tsepin Tsai, Muguo Chen and Lin-Feng Li, filed Jan. 11, 2000; U.S. Ser. No. 09/943,053 entitled “Polymer Matrix Material”, by Robert Callahan, Mark Stevens and Muguo Chen, filed on Aug. 30, 2001; and U.S. Ser. No. 09/942,887 entitled “Electrochemical Cell Incorporating Polymer Matrix Material”, by Robert Callahan, Mark Stevens and Muguo Chen, filed on Aug. 30, 2001; all of which are incorporated by reference herein in their entireties.

In certain embodiments, the polymeric material used as separator comprises a polymerization product of one or more monomers selected from the group of water soluble ethylenically unsaturated amides and acids, and optionally a water soluble or water swellable polymer. The polymerized product may be formed on a support material or substrate. The support material or substrate may be, but not limited to, a woven or nonwoven fabric, such as a polyolefin, polyvinyl alcohol, cellulose, or a polyamide, such as nylon.

The electrolyte may be added prior to polymerization of the above monomer(s), or after polymerization. For example, in one embodiment, electrolyte may be added to a solution containing the monomer(s), an optional polymerization initiator, and an optional reinforcing element prior to polymerization, and it remains embedded in the polymeric material after the polymerization. Alternatively, the polymerization may be effectuated without the electrolyte, wherein the electrolyte is subsequently included.

The water soluble ethylenically unsaturated amide and acid monomers may include methylenebisacrylamide, acrylamide, methacrylic acid, acrylic acid, 1-vinyl-2-pyrrolidinone, N-isopropylacrylamide, fumaramide, fumaric acid, N,N-dimethylacrylamide, 3,3dimethylacrylic acid, and the sodium salt of vinylsulfonic acid, other water soluble ethylenically unsaturated amide and acid monomers, or combinations comprising at least one of the foregoing monomers.

The water soluble or water swellable polymer, which acts as a reinforcing element, may include polysulfone (anionic), poly(sodium 4-styrenesulfonate), carboxymethyl cellulose, sodium salt of poly(styrenesulfonic acid-co-maleic acid), corn starch, any other water-soluble or water-swellable polymers, or combinations comprising at least one of the foregoing water soluble or water swellable polymers. The addition of the reinforcing element enhances mechanical strength of the polymer structure.

Optionally, a crosslinking agent, such as methylenebisacrylamide, ethylenebisacrylamide, any water-soluble N,N′-alkylidene-bis(ethylenically unsaturated amide), other crosslinkers, or combinations comprising at least one of the foregoing crosslinking agents.

A polymerization initiator may also be included, such as ammonium persulfate, alkali metal persulfates and peroxides, other initiators, or combinations comprising at least one of the foregoing initiators. Further, an initiator may be used in combination with radical generating methods such as radiation, including for example, ultraviolet light, X-ray, γ-ray, and the like. However, the chemical initiators need not be added if the radiation alone is sufficiently powerful to begin the polymerization.

In one method of forming the polymeric material, the selected fabric may be soaked in the monomer solution (with or without the ionic species), the solution-coated fabric is cooled, and a polymerization initiator is optionally added. The monomer solution may be polymerized by heating, irradiating with ultraviolet light, gamma-rays, x-rays, electron beam, or a combination thereof, wherein the polymeric material is produced. When the ionic species is included in the polymerized solution, the hydroxide ion (or other ions) remains in solution after the polymerization. Further, when the polymeric material does not include the ionic species, it may be added by, for example, soaking the polymeric material in an ionic solution.

Polymerization is generally carried out at a temperature ranging from room temperature to about 130° C., but preferably at an elevated temperature ranging from about 75° to about 100° C. Optionally, the polymerization may be carried out using radiation in conjunction with heating. Alternatively, the polymerization may be performed using radiation alone without raising the temperature of the ingredients, depending on the strength of the radiation. Examples of radiation types useful in the polymerization reaction include, but are not limited to, ultraviolet light, gamma-rays, x-rays, electron beam, or a combination thereof.

To control the thickness of the membrane, the coated fabric may be placed in suitable molds prior to polymerization. Alternatively, the fabric coated with the monomer solution may be placed between suitable films such as glass and polyethylene teraphthalate (PET) film. The thickness of the film may be varied will be obvious to those of skill in the art based on its effectiveness in a particular application. In certain embodiments, for example for separating oxygen from air, the membrane or separator may have a thickness of about 0.1 mm to about 0.6 mm. Because the actual conducting media remains in aqueous solution within the polymer backbone, the conductivity of the membrane is comparable to that of liquid electrolytes, which at room temperature is significantly high. In still further embodiments of the separator, anion exchange membranes are employed. Some exemplary anion exchange membranes are based on organic polymers comprising a quaternary ammonium salt structure functionality; strong base polystyrene divinylbenzene cross-linked Type I anion exchangers; weak base polystyrene divinylbenzene cross-linked anion exhangers; strong base/weak base polystyrene divinylbenzene cross-linked Type II anion exchangers; strong base/weak base acrylic anion exchangers; strong base perfluoro aminated anion exchangers; naturally occurring anion exchangers such as certain clays; and combinations and blends comprising at least one of the foregoing materials. An exemplary anion exchange material is described in greater detail in U.S. Provisional Patent Application No. 60/307,312 entitled “Anion Exchange Material”, by Muguo Chen and Robert Callahan, filed on Jul. 23, 2001, and incorporated by reference herein.

Another example of a suitable anion exchange membrane is described in greater detail in U.S. Pat. No. 6,183,914 and incorporated by reference herein. The membrane includes an ammonium-based polymer comprising (a) an organic polymer having an alkyl quaternary ammonium salt structure; (b) a nitrogen-containing, heterocyclic ammonium salt; and (c) a source of hydroxide anion.

In yet another embodiment, mechanical strength of the resulting membrane may be increased by casting the composition on a support material or substrate, which is preferably a woven or nonwoven fabric, such as a polyolefin, polyester, polyvinyl alcohol, cellulose, or a polyamide, such as nylon.

An alternative configuration for a metal air cell 110 is shown in FIG. 2. Cell 110 comprises an anode 112, a cathode 114, and a separator 116 between the anode 112 and the cathode 114. The cathode 114 comprises two portions, which may be electrically connected to allow both portions, which are in ionic communication with at least two major surfaces of the anode 112. The anode 112 is configured as a wedge, which in part facilitates removal thereof, generally for refueling the cell 110. The wedge may have various angles, depending on factors including but not limited to space constraints and desired contact area between the anode 112 and the cathode 114.

The cathode 114 is supported by a structure 118, which may be formed of a suitable material that is capable of supporting the cathode 114 and preferably is inert with the cell chemistry. Further, the structure 118 is configured with open areas or manifolds (not shown) to provide oxidant to the cathode 114. Alternatively, the structure 118 may be configured to allow expansion thereof, for example to facilitate removal of the anode 112 and compensate for anode expansion.

Referring now to FIGS. 3-7, a method of manufacturing an anode structure 232 is shown. Generally, an anode 212 and an electrolyte 224 are integrally formed, and a separator 216 is provided to at least partially contain the electrolyte 224. Preferably, the anode structure 232 is constructed from appropriate materials and is configured to maximize the reaction of the metal constituent within the electrolyte, which will enhance the capacity of a metal air cell. Thus, an effective amount of electrolyte is preferably maintained consistent with the amount of metal reacted.

The anode 212 (FIG. 3) generally comprises a metal constituent and optionally a binder and an additive, which are presses together into a substantially solid form. A current collector 220 is embedded within the anode 212. In certain embodiments, the current collector 220 also functions as a handle to facilitate removal and insertion of the anode structure for refueling. Additionally, an electrolyte 224 is provided, for example in solution comprising water, a base such as KOH or NaOH, an effective amount of gelling agent, and optionally other additives such as an anti-corrosion additive. The solution may be cured, for example by reducing the temperature, or the solution may coagulate without a curing step with passage of sufficient time.

The anode 212 is then substantially submerged within a vessel 222 containing an electrolyte solution 224 (FIG. 4). The submerged anode may be allowed to sit for some time to allow migration of the electrolyte to the anode, or the vessel 222 having the anode 212 and electrolyte 224 therein may be directly placed into a vacuum, for example in a pressure chamber or the like, to remove air from the system and allow for absorption of electrolyte 224 into the anode 212. When the vacuum is released, electrolyte will soak into the anode 212.

In an optional step, prior to submerging the anode 212 into the vessel 222, the anode 212 and/or the electrolyte are de-aired, such as in a vacuum chamber. Removal of excess air from the anode 212 and/or the electrolyte minimizes likelihood of corrosion of the anode 212, especially during storage. Furthermore, removal of excess air, particularly from the anode 212, frees up additional volume within the anode 212 for electrolyte to fill. When both the anode 212 and the vessel 222 are de-aired, an apparatus may be used to submerge the anode 212 into the vessel. The vacuum process may continue to remove additional air and assist absorption of electrolyte 224 into the anode 212, or the vacuum may be removed, allowing for further absorption of electrolyte 224 into the anode 212. Therefore, any detrimental effects due to the removal of the anode 212 and vessel 222 from the vacuum chamber will be minimized, and absorption of electrolyte 224 into the anode 212 will be maximized.

In another optional step, after the vacuum is released, the anode 212 with electrolyte 224 absorbed therein (either within the vessel 222 or removed therefrom) is subjected to pressure within a pressure chamber, preferably the same pressure chamber as used for the vacuum step(s) to minimize transition detriments. This provides additional absorption of electrolyte 224 into the anode 212.

The next step is to form the separator 216 upon the anode 212 having electrolyte 224 absorbed therein. Referring to FIG. 5, the separator 216 is placed within a casting mold 228. The anode 212 having electrolyte 224 absorbed therein, further having excess electrolyte on the surface thereof, is inserted into the mold 228 with the separator 216. The excess electrolyte is absorbed by the separator 216. Alternatively, electrolyte can also be placed within the mold before or after the separator 216 is inserted.

When the electrolyte has gelled (either after passage of sufficient time or with curing), the anode structure 232 can be removed from the mold 228, wherein the separator 216 is integrally formed with the anode 212 having electrolyte absorbed therein. FIG. 7 shows a detail of the separator 216 having a layer 236 of electrolyte between the separator 216 and the anode 212, and a layer 238 of electrolyte on the outside of the separator 216. Therefore, the anode surface having one or more additional layers of electrolyte provides volume for at least a portion, and preferably substantially all, of the anode expansion after cell discharge. This surface coating also minimizes detriments due to temperature increase during discharge of the cell. Temperature is increased generally because the zinc oxidation increases the internal resistance of the anode. With the electrolyte layers, the viscosity of the fluid at the anode surface remains low while the anode temperature increase, which will help to contain the anode expansion and reduce the possibility of cell damage.

In an alternative method, at least a portion of the electrolyte is in solid form, which is integrally formed with the metal constituent of the anode. The electrolyte may be, pressed, sintered, and/or heated together with the metal (and typically a binder). The electrolyte can be in strips or sheets as is effective, or alternatively in powder, granule, pellet, or other form. This may be done in conjunction with the above-described vacuum steps, wherein the anode having electrolyte (solid) formed therein may be de-aired and optionally further pressurized. Additionally, the aqueous electrolyte may also be used, wherein the liquid electrolyte is absorbed as described above.

While the anode structure has been described herein having substantially a wedge shape, the anode structure may be formed in various shapes. For example, referring to FIG. 8, an anode structure 332 is shown having a substantially rectangular shape. The anode structure may be formed in alternative shapes, including but not limited to, cylindrical, conical, frustoconical, circular, and the like, depending on the cell configuration.

The anode detailed herein provides various benefits. The contained system of an anode and the electrolyte allows for efficient refueling of a cell, limited to removing a spent anode structure and replacing it with a fresh anode structure. Since sufficient electrolyte is generally provided in the anode structure, no additional step of adding electrolyte is required, preventing electrolyte contamination during the refueling process. Furthermore, since the separator is formed integrally with the anode structure, air bubbles or pockets between the separator and the anode are minimized or eliminated. Also, the anode surface having one or more additional layers of electrolyte provides volume for at least a portion, and preferably substantially all, of the anode expansion after cell discharge. In addition, this anode package should be easy to use and handle. Additionally, anode corrosion caused by air dissolved in the electrolyte is substantially reduced, prolonging the anode shelf life.

While preferred embodiments have been shown and described, various modifications and substitutions may be made thereto without departing from the spirit and scope of the invention. Accordingly, it is to be understood that the present invention has been described by way of illustrations and not limitation.

What is claimed is:

1. A method for making an anode structure comprising:
providing an anode within an electrolyte solution;
subjecting the anode within the electrolyte solution to a vacuum and releasing the vacuum, wherein electrolyte is absorbed into the anode; and
forming a separator around at least a portion of the anode having electrolyte absorbed therein.

2. The method as in claim 1, wherein the anode is de-aired prior to being provided with the electrolyte solution.

3. The method as in claim 1, wherein the electrolyte solution is de-aired prior to having the anode inserted therein.

4. The method as in claim 1, wherein the anode within the electrolyte solution is subjected to pressure after releasing the vacuum.

5. The method as in claim 1, wherein the separator is provided in a mold, and the anode having the electrolyte solution therein is provided in the separator within the mold.
